(19) United States
(12) Patent Application Publication
(10) Pub. No.: US 2019/0016250 A1
(43) Pub. Date: Jan. 17, 2019

(54) METHOD AND DEVICE FOR ADAPTING A FRONT LIGHT OF A VEHICLE

(71) Applicant: Robert Bosch GmbH, Stuttgart (DE)

(72) Inventor: Lenne Ahrens, Heilbronn (DE)

(21) Appl. No.: 16/010,971

(22) Filed: Jun. 18, 2018

(30) Foreign Application Priority Data
Jul. 12, 2017 (DE) 102017211888.1

(51) Int. Cl. B60Q 1/14; B60Q 1/08; G06K 9/00

(52) U.S. Cl. CPC B60Q 1/1423; B60Q 1/08; B60Q 2300/314; B60Q 2300/052; G06K 9/00791

(57) ABSTRACT

A method and a device for adapting a front light of a vehicle, the front light illuminating a region in front of the vehicle, having a step of detecting at least one further vehicle which carries out a passing maneuver for passing the vehicle, and a step of adapting the front light in such a way that the at least one further vehicle is not blinded by the front light following the passing maneuver and the front light continues to illuminate the region in front of the vehicle in an at least partially unchanged manner.

### CROSS REFERENCE

The present application claims the benefit under 35 U.S.C. § 119 of German Patent Application No. DE 102017211888.1 filed on Jul. 12, 2017, which is expressly incorporated herein by reference in its entirety.

### SUMMARY

The present invention relates to a method and a device for adapting a front light of a vehicle, including a step of detecting at least one further vehicle which carries out a passing maneuver, and a step of adapting the front light in such a way that the at least one further vehicle will not be blinded by the front light following the passing maneuver and the front light continues to illuminate the region in front of the vehicle in an at least partially unchanged manner.

An example method according to the present invention for adapting a front light of a vehicle, the front light illuminating a region in front of the vehicle, includes a step of detecting at least one further vehicle that carries out a passing maneuver for passing the vehicle, and it includes a step of adapting the front light in such a way that the at least one further vehicle will not be blinded by the front light following the passing maneuver and the front light continues to illuminate the region in front of the vehicle in an at least partially unchanged manner.

The expression that the front light continues to illuminate the region in front of the vehicle in an at least partially unchanged manner means that the region in front of the vehicle continues to be illuminated at least in such a way that an operator of the vehicle and/or at least one sensor of the vehicle is/are able to detect the region in such a way that a safe operation of the vehicle is ensured.

This provides the advantage that both the operation of the vehicle continues to be ensured and that blinding of the at least one passing vehicle is impossible.

The at least one further vehicle is preferably detected with the aid of an environment-sensor system and/or the at least one vehicle is detected with the aid of a radio link between the vehicle and the at least one further vehicle.

An environment-sensor system of the vehicle, for example, is to be understood as one or more camera(s) and/or one or more radar sensor(s), and/or one or more lidar sensor(s), and/or one or more ultrasonic sensor(s), and/or at least one further sensor, which is developed to detect the at least one further vehicle.

A radio link between the vehicle and the at least one further vehicle, for example, is what is known as a C2C (car-to-car) connection. In one specific embodiment, the radio link is not realized directly between the vehicle and the at least one further vehicle but, for instance, by way of an intermediate station such as an external server (e.g., of a mobile service provider).

Both methods for detecting the at least one further vehicle offer the advantage that the at least one further vehicle is detected in a reliable and rapid manner. If the at least one further vehicle is detected both with the aid of an environment-sensor system and a radio link, then this offers the additional advantage that both methods are able to plausibilize each other.

The at least one further vehicle is preferably detected in that a velocity of the at least one further vehicle and/or a distance between the vehicle and the at least one further vehicle is/are detected in addition.

For instance, the velocity is detected in that the at least one further vehicle is detected over a certain period of time, the distance of the at least one further vehicle from the vehicle relative to the direction of travel of the vehicle and relative to the velocity of the vehicle is detected, and the velocity of the at least one further vehicle is derived from this distance, the velocity of the vehicle and the time period of the detection.

This may offer an advantage that the moment at which the front light has to be adapted is able to be determined in a precise manner.

The adaptation of the front light is preferably carried out in such a way that the passing maneuver of the at least one further vehicle is additionally supported according to predefined criteria.

This offers the advantage that both the vehicle and the at least one further vehicle are safely operated during the passing maneuver.

The at least one further vehicle is preferably not blinded following the passing maneuver in that a person in the at least one further vehicle is not blinded and/or in that at least one sensor of the at least one further vehicle is not blinded.

This offers the advantage that both the vehicle and the at least one further vehicle are safely operated also following the passing maneuver.

An example device according to the present invention for adapting a front light of a vehicle, the front light illuminating a region in front of the vehicle, includes a first device for detecting at least one further vehicle that carries out a passing maneuver for passing the vehicle, and it includes a second device for adapting the front light in such a way that the at least one further vehicle is not blinded by the front light following the passing maneuver and the front light continues to illuminate the region in front of the vehicle in an at least partially unchanged manner.

The first device is preferably developed in such a way that the at least one further vehicle is detected with the aid of an environment-sensor system of the vehicle, and/or the first device is developed as a transmission and/or as a receiving unit so that the at least one vehicle is detected with the aid of a radio link between the vehicle and the at least one further vehicle, and/or the first device is developed in such a way that the at least one further vehicle is detected in that a velocity of the at least one further vehicle and/or a distance between the vehicle and the at least one further vehicle is/are detected in addition.

The second device is preferably developed in such a way that the adapting of the front light is carried out in such a manner that the passing maneuver of the at least one further vehicle is additionally supported according to predefined criteria.

Within the scope of the present invention, an adaptation of the front light means that at least one headlight of the vehicle, which emits light toward the front relative to the vehicle is controlled in such a way that a light emission of the at least one headlight is adapted or modified. No further differentiation is therefore made between the front light and the at least one headlight—at the front of the vehicle.

Advantageous further developments of the present invention are described herein.

### BRIEF DESCRIPTION OF THE DRAWINGS

Exemplary embodiments of the present invention are shown in the figures and are described in greater detail below.

FIG. 1 shows, purely by way of example, an exemplary embodiment of the device according to the present invention, which is encompassed by a vehicle.

FIGS. 2a, 2b and 2c show, purely by way of example, an exemplary embodiment of the method according to the present invention.

FIG. 3 shows, purely by way of example, an exemplary embodiment of the method according to the present invention in the form of a flow diagram.

### DETAILED DESCRIPTION OF EXAMPLE EMBODIMENTS

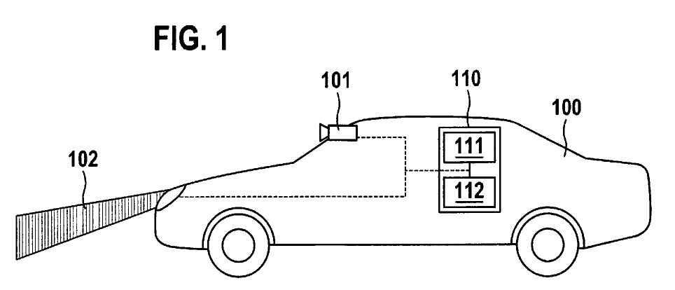

FIG. 1 shows a vehicle 100, which includes device 110 according to the present invention. Device 110 for adapting 320 a front light 102 of a vehicle 100, front light 102 illuminating a region 200 in front of vehicle 100, includes first device 111 for detecting 310 at least one further vehicle 210, which carries out a passing maneuver for passing vehicle 100, and it includes second device 112 for adapting 320 front light 102 in such a way that the at least one further vehicle 210 will not be blinded by front light 102 following the passing maneuver and front light 102 continues to illuminate the region 200 in front of vehicle 100 in an at least partially unchanged manner.

First device 111, for example, is developed as a processing unit and/or as a control unit, which include(s) a processor, a working memory, a hard drive as well as software for detecting the at least one further vehicle 210.

In one specific embodiment, first device 111 is developed in such a way, for instance, that the at least one further vehicle 210 is detected with the aid of an environment-sensor system 101 of vehicle 100, and/or first device 111 is developed as a transmission and/or as a receiving unit so that the at least one further vehicle 210 is detected with the aid of a radio link between vehicle 100 and the at least one further vehicle 210.

In one further specific embodiment, first device 111 is additionally or alternatively developed so that the at least one further vehicle 210 is detected in that a velocity of the at least one further vehicle 210 and/or a distance between vehicle 100 and the at least one further vehicle 210 is/are detected in addition.

Second device 112, for example, is developed as a control unit, which is developed to actuate and/or adapt at least front light 102 of the vehicle.

In one further specific embodiment, the second device 112 is developed in such a way that the adapting 320 of front light 102 is carried out in such a manner that the passing maneuver of the at least one further vehicle 210 is additionally supported according to predefined criteria.

The predefined criteria, for instance, are to be understood in such a way that a further region is illuminated that the person in the at least one further vehicle 210 would not be able to see without front light 102 of vehicle 100, and/or that the at least one sensor of the at least one further vehicle 210 would not be able to detect.

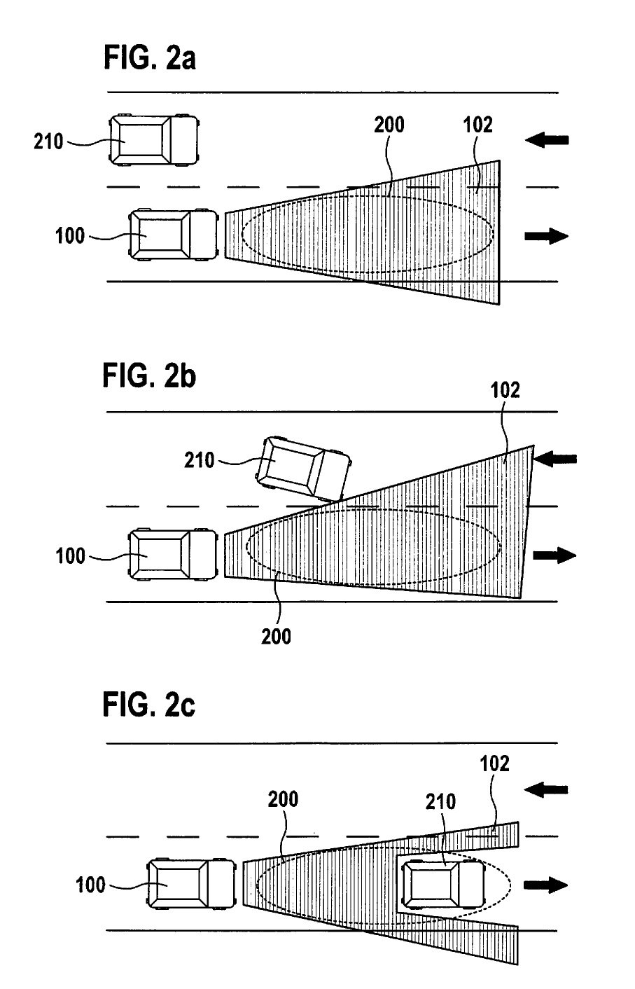

FIG. 2 shows an exemplary embodiment of method 300 according to the present invention, in which the form of the illumination of the respectively shown front light 102 is illustrated schematically and purely by way of example. In addition, for example, a two-lane road is shown, which has one traffic lane for each direction of travel. In one further specific embodiment, the passing maneuver of vehicle 100 by the at least one further vehicle 210 is carried out on a highway that has multiple traffic lanes having the same direction of travel, for example. It is unimportant in this context whether the at least one further vehicle 210 returns to the same traffic lane that is used by vehicle 100 following the passing maneuver or whether it concludes the passing maneuver and remains in an adjacent traffic lane.

In FIG. 2a, front light 102 of vehicle 100 illuminates a region 200 in front of vehicle 100, and the at least one further vehicle 210, which carries out a passing maneuver for passing vehicle 100, is detected.

In FIG. 2c, front light 102 is adapted in such a way that the at least one further vehicle 210 is not blinded by front light 102 following the passing maneuver and front light 102 continues to illuminate region 200 in front of vehicle 100 in an at least partially unchanged manner. The expression that the at least one further vehicle 210 is not blinded is to be understood in such a way that a person in the at least one further vehicle 210 and/or a sensor of the at least one further vehicle 210, for instance, is/are not blinded. This is done, for example, in that front light 102 is adapted in such a way that the at least one further vehicle 210 is not illuminated by front light 102 or, at most, is illuminated by front light 102 in such a way that certain regions are excluded.

For instance, these regions are determined with the aid of environment-sensor system 101 of vehicle 100 (on the basis of predefined features of the at least one further vehicle 210 that are stored in a memory, for example) or, if the at least one further vehicle 210 is detected with the aid of a radio link between vehicle 100 and the at least one further vehicle 210, for instance, these regions are transmitted as well.

FIG. 2b shows a specific embodiment, which is additionally executed in that front light 102 is adapted in such a way that the passing maneuver of the at least one further vehicle 210 is additionally supported according to predefined criteria, for instance.

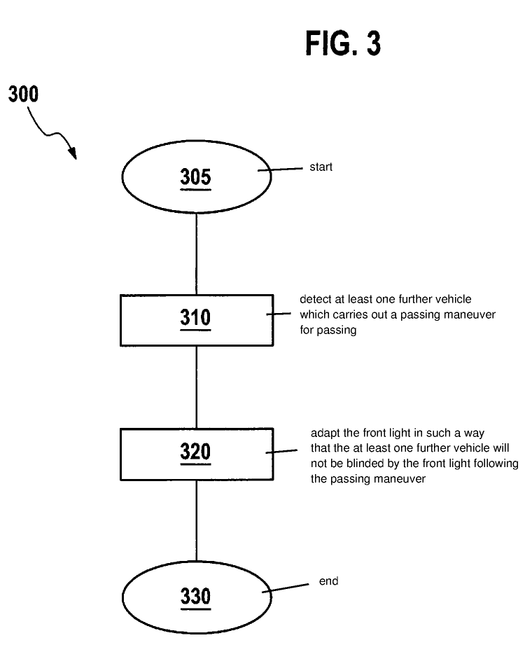

FIG. 3 shows an exemplary embodiment of method 300 according to the present invention for adapting 320 a front light 102 of a vehicle 100, in the form of a flow diagram.

Method 300 starts in step 305. For instance, this is done in that environment-sensor system 101 of vehicle 100 continuously detects an environment of vehicle 100 following the startup of an engine of vehicle 100.

In step 310, at least one further vehicle 210 is detected which carries out a passing maneuver for passing vehicle 100. For example, the fact that the at least one further vehicle 210 is carrying out a passing maneuver is detected in that the velocity and/or the distance of the at least one further vehicle 210 relative to vehicle 100 is/are detected.

In step 320, front light 102 is adapted in such a way that the at least one further vehicle 210 will not be blinded by front light 102 following the passing maneuver and front light 102 continues to illuminate region 200 in front of vehicle 100 in an at least partially unchanged manner.

Method 300 ends in step 330. For example, this takes place in that the at least one further vehicle 210 leaves region 200 of vehicle 100 in such a way that region 200 in front of vehicle 100 is able to be illuminated in a completely unchanged manner without the at least one further vehicle 210 being blinded.

What is claimed is:

1. A method for adapting a front light of a vehicle, in which the front light illuminates a region in front of the vehicle, the method comprising:
detecting at least one further vehicle, which carries out a passing maneuver for passing the vehicle; and
adapting the front light in such a way that the at least one further vehicle is not blinded by the front light following the passing maneuver, and the front light continues to illuminate the region in front of the vehicle in an at least partially unchanged manner.

2. The method as recited in claim 1, wherein at least one of:
(i) the at least one further vehicle is detected with the aid of an environment-sensor system of the vehicle, and (ii) the at least one further vehicle is detected with the aid of a radio link between the vehicle and the at least one further vehicle.

3. The method as recited in claim 2, wherein the at least one further vehicle is detected in that at least one of: (i) a velocity of the at least one further vehicle, and (ii) a distance between the vehicle and the at least one further vehicle, is detected.

4. The method as recited in claim 1, wherein the adapting of the front light is carried out in such a way that the passing maneuver of the at least one further vehicle is supported according to predefined criteria.

5. The method as recited in claim 1, wherein the at least one further vehicle is not blinded following the passing maneuver in that at least one of: (i) a person in the at least one further vehicle is not blinded, and (ii) at least one sensor of the at least one further vehicle is not blinded.

6. A device for adapting a front light of a vehicle, the front light illuminating a region in front of the vehicle, the device comprising:
a first device for detecting at least one further vehicle which carries out a passing maneuver for passing the vehicle; and
a second device for adapting the front light in such a way that the at least one further vehicle is not blinded by the front light following the passing maneuver, and the front light continues to illuminate the region in front of the vehicle in an at least partially unchanged manner.

7. The device as recited in claim 6, wherein at least one of:
(i) the first device is developed in such a way that the at least one further vehicle is detected with the aid of an environment-sensor system of the vehicle, (ii) the first device is developed as at least one of a transmission and a receiving unit, so that the at least one further vehicle is detected with the aid of a radio link between the vehicle and the at least one further vehicle, and (iii) the first device is developed in such a way that the at least one further vehicle is detected in that at least one of a velocity of the at least one further vehicle, and a distance between the vehicle and the at least one further vehicle, is detected.

8. The device as recited in claim 6, wherein the second device is developed in such a way that the adapting of the front light is carried out in such a way that the passing maneuver of the at least one further vehicle is supported according to predefined criteria.
